(19) United States
(12) Patent Application Publication
(10) Pub. No.: US 2007/0228795 A1
(43) Pub. Date: Oct. 4, 2007

(54) Seat for a driver of a construction machine, as well as construction machine

(75) Inventors: Heiko Boehme, Vettelschoss (DE); Urban Kurscheid, Koenigswinter (DE); Christian Berning, Zuelpich (DE)

Correspondence Address: DILLER, RAMIK & WIGHT, 7345 MCWHORTER PLACE, SUITE 101, ANNANDALE, VA, 22003, US

(73) Assignee: Wirtgen GmbH

(21) Appl. No.: 11/723,557

(22) Filed: Mar. 21, 2007

(30) Foreign Application Priority Data
Mar. 31, 2006 (DE) 10 2006 015 504.1

(51) Int. Cl. B60N 2/00

(52) U.S. Cl. 297/354.1

(57) ABSTRACT

In a seat (1) for a driver of a construction machine, in particular a road milling machine, with a first seat surface (2) for the driver in a sitting position and a backrest (4), it is provided that the backrest (4) is capable of being tilted towards the front in the direction of the driver to at least one rest position, in which a second seat surface (8) is formed for the driver when in an essentially standing position, which is arranged at the upper end of the backrest (4).

### BACKGROUND OF THE INVENTION

The invention concerns a seat for a driver of a construction machine, in particular a road milling machine, as well as a construction machine.

Such an automotive road milling machine is known, for instance, from EP 1194651 B.

The problem occurs, in particular with road milling machines, that the driver must change his position frequently, spending about 50% of the working time standing and 50% sitting. In road milling machines, the seat for the driver is arranged on the zero side, which is that side of the machine where a side edge of the milling drum is more or less flush with or has only a small distance to the side of the machine in order to be able to mill as closely as possible along an obstacle, such as a kerbstone or crash barrier.

Working in the standing position, in particular, is very tiring for the driver. An additional problem is that the driver has his hands on the operating elements also when driving in the standing position. When driving across uneven terrain or over obstacles, this leads to inadvertent changes in the direction of travel and speed.

The purpose of the invention is, therefore, to create a seat for a driver of a construction machine, as well as a construction machine with such a seat, which enable an ergonomic sitting and standing position.

### SUMMARY OF THE INVENTION

The invention provides in an advantageous manner that the backrest is capable of being tilted towards the front in the direction of the driver to at least one rest position, in which a second seat surface arranged at the upper end of the backrest is formed for the driver when in an essentially standing position.

Such a seat ensures not only an ergonomic seating position but an ergonomic standing position as well, in which the driver can lean against the second seat surface when required to operate the vehicle in a standing position. This is necessary when, for instance, the driver must drive the construction machine along an edge, where aiming via the front edge of the milling drum housing on the zero side is required.

When it is not necessary to watch the machine in a standing position, the driver may sit down and operate his vehicle from the sitting position after the backrest has been returned to an upright position. Aiming is possible via a guide rod at the front end of the machine when working in a sitting position.

The backrest may display a head part that is arranged at the upper free end of the backrest, with the head part of the backrest providing the second seat surface for the driver when in an essentially standing position. The second seat surface for the driver is formed in a particularly advantageous manner in the head part.

The backrest may be capable of being locked towards the front in the direction of the first seat surface in at least one rest position. In this way, the backrest can be brought into a position adapted to the standing positions of the driver and can be locked in the said position. An adaptation to drivers of different body height is possible also.

The second seat surface may consist of an even surface or of a concavely shaped seat surface.

The head part may be mounted to pivot towards the front around a horizontal axis. This allows the second seat surface to be adapted to the standing position of the driver. The second seat surface is arranged on the side of the head part that normally faces away from the head of the driver, for instance, also on the top.

The first seat surface may be height-adjustable, which enables the height of the backrest to be changed as well and to be adapted to an individual driver. An advantageous embodiment provides that the head part (12) is height-adjustable and suitable for being used as a headrest.

For the driver's sitting position, a footrest may be arranged at the seat in such a manner that, for the driver's sitting position, a footrest (14) is arranged at the seat (1) in such a manner that the first seat surface (2) can be arranged at a height in which the upper body of a driver has essentially the same height position when sitting and when standing, and that the footrest (14) is capable of being removed for the standing position of the driver.

It is achievable by means of the footrest that the operating elements for driving and steering the construction machine as well as the steering wheel are at essentially the same height relative to the upper body of the driver both in the sitting position and in the standing position of the driver so that an adjustment in height of the operating elements is not required.

For the driver's standing position, the footrest is preferably swung away upwards, by way of which the driver assumes a lower position so that the upper body is at essentially the same height when sitting or when standing.

When tilted into the forward position, the backrest may be capable of being locked at an angle of 20 to 50°, preferably 30 to 40°, to the horizontal line.

When tilting towards the front, the backrest may be coupled to the footrest in such a manner that, in the forward-tilted position of the backrest, the footrest is in the swung-away position or in any other inactive position.

The seat may be adjustable in height altogether in order to be capable of being adapted to the body height of a driver.

The seat may be capable of being displaced altogether both transversely and in or against the direction of travel or may be capable of being tilted towards the front.

The invention also concerns a construction machine, in particular a road milling machine, with the seat described.

In the following, one embodiment of the invention is explained in more detail with reference to the drawings.

### BRIEF DESCRIPTION OF THE DRAWINGS

FIG. 1 is a vehicle seat with a driver in a sitting position.

FIG. 2 is a seat with tilted backrest which offers the driver a second seat surface.

### DESCRIPTION OF THE PREFERRED EMBODIMENTS

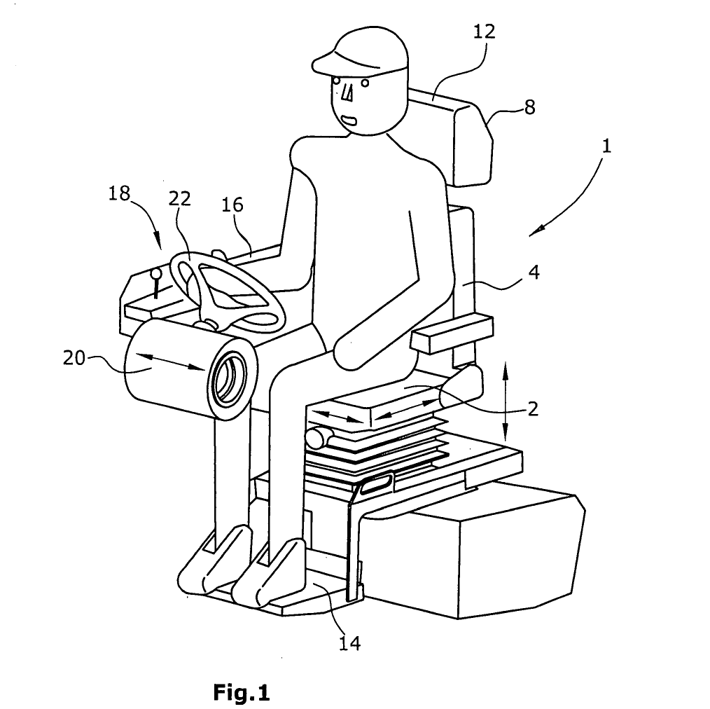

FIG. 1 shows a seat 1 for a driver of a construction machine, in particular a construction machine that has to be steered and driven along a pre-determined line, which requires the driver to watch in particular one side wall of the construction machine in a standing position.

It is possible to generally steer the construction machine from the sitting position shown in FIG. 1. If the construction machine is to be driven along a line, however, a standing position is more convenient when the guideline is on one side of the machine and monitoring is required as to whether the construction machine moves along that line. It is known with road milling machines that one side edge of the milling drum is nearly flush with one side wall of the construction machine (zero side) so that, when milling has to be carried out along an edge like, for instance, a kerbstone or crash barrier, the driver must watch from a standing position as to whether the construction machine has been guided sufficiently close to the obstacle.

The seat 1 depicted in FIG. 1 shows a first seat surface 2 for the driver in a sitting position as well as a backrest 4 that may have a head part 8 at its upper end. The seat 1 may be height-adjustable altogether, and may also be moved transversely to the direction of travel, meaning laterally, or forward and backward in or against the direction of travel. The seat 1 is adjustable in height in order to enable the driver to assume a comfortable, ergonomic position relative to the operating elements 18 and 22, with a folding footrest 14 providing a support for the legs of the driver.

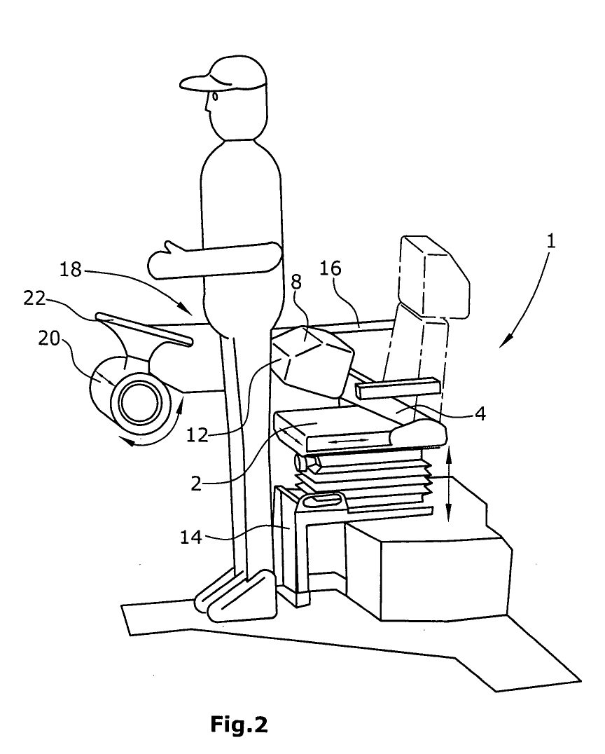

The steering wheel 22 is arranged in a bracket 20 pivoting around a horizontal axis of rotation and can be pivoted to the lower position, which can be seen from FIG. 2, for the standing position. Moreover, it is also possible to adjust the steering wheel 22 transversely to the direction of travel, meaning axially relative to the axis of rotation of the bracket 20.

An armrest 16 for supporting the right arm is located behind the operating elements 18 for the driver.

The backrest 4 of the seat 1, which can preferably be tilted around a horizontal axis of the seat in the direction of the first seat surface 2, may be of two-part design and may show a height-adjustable head part 12.

As can best be seen from FIG. 2, the backrest 4 can be brought into a forward-tilted position, where the head part 12 offers a second seat surface 8 on which the driver can support himself when in the standing position so that he will tire less quickly when standing.

In this case, the folding footrest 14 can be swung away upwards so that the driver can stand on the platform of the road construction machine. The difference in height of the position of the driver's upper body between the sitting position and the standing position can be reduced by means of the folding footrest 14, so that the operating elements 18 are within good reach both in the sitting and in the standing position.

The footrest 14 may also be coupled to the backrest 4 in such a manner that, when tilting the backrest 4 into the forward position, the footrest 14 is simultaneously swung away upwards.

It is understood that the second seat surface can also be shaped in an extended backrest 4 without head part 12 at the upper end of the backrest on the side that normally faces away from the driver.

The second seat surface is depicted as an even surface in the drawings but may also be adapted ergonomically to the body contour of the driver, e.g. may be of concave shape.

It is also possible that the backrest 4 is capable of being locked in different positions in order to adapt to the body height of different drivers.

The tilting angle to the horizontal line, in which the backrest 4 is capable of being locked, is in the range between 20 and 50°, preferably 30 to 40°, with a tilting angle of the backrest of approx. 35° having proved to be particularly advantageous.

What is claimed is:

1. A seat (1) for a driver of a construction machine, in particular a road milling machine, with
a first seat surface (2) for the driver in a sitting position, and
a backrest (4),
characterized in that,
the backrest (4) is capable of being tilted towards the front in the direction of the driver to at least one rest position, in which a second seat surface (8) is formed for the driver when in an essentially standing position, which is arranged at the upper end of the backrest (4).

2. The device in accordance with claim 1, characterized in that the backrest (4) displays a head part (12) that is arranged at the upper free end of the backrest (4), and that the head part (12) of the backrest (4) provides the second seat surface (8) for the driver when in an essentially standing position.

3. The device in accordance with claim 1, characterized in that the backrest (4) is capable of being locked towards the front in the direction of the first seat surface (2) in at least one rest position.

4. The device in accordance with claim 1, characterized in that the second seat surface (8) consists of an even surface.

5. The device in accordance with claim 1, characterized in that the second seat surface (8) is of a concave shape.

6. The device in accordance with claim 2, characterized in that the head part (12) is mounted to pivot towards the front around a horizontal axis.

7. The device in accordance with claim 2, characterized in that the second seat surface (8) is arranged on the side of the head part (12) that normally faces away from the head of the driver and/or is arranged on the top of the head part (12).

8. The device in accordance with claim 1, characterized in that the first seat surface (2) is height-adjustable.

9. The device in accordance with claim 2, characterized in that the head part (12) is height-adjustable and is suitable for being used as a headrest.

10. The device in accordance with claim 1, characterized in that, for the driver's sitting position, a footrest (14) is arranged at the seat (1) in such a manner that the first seat surface (2) can be arranged at a height in which the upper body of a driver has essentially the same height position when sitting and when standing, and that the footrest (14) is capable of being removed for the standing position of the driver.

11. The device in accordance with claim 1, characterized in that the backrest (4), when tilted to the forward position, is capable of being locked at an angle of 20° to 50°, preferably 30° to 40°, to the horizontal line.

12. The device in accordance with claim 1, characterized in that the backrest (4), when tilting into the forward position, is coupled to the footrest (14) in such a manner that the footrest (14) is in the removed position when the backrest (4) is in the forward-tilted position.

13. The device in accordance with claim 1, characterized in that the seat (1) is adjustable in height altogether.

14. The device in accordance with claim 1, characterized in that the seat (1) is capable of being displaced altogether transversely and/or in or against the direction of travel.

15. The construction machine, in particular road milling machine, with a seat for a driver in accordance with claim 1.

16. The device in accordance with claim 2, characterized in that the backrest (4) is capable of being locked towards the front in the direction of the first seat surface (2) in at least one rest position.
